(19) United States
(12) Patent Application Publication
(10) Pub. No.: US 2026/0216809 A1
(43) Pub. Date: Jul. 30, 2026

(54) WELDING CONTROL METHOD, WELDING SYSTEM, AND WELDING CONTROL PROGRAM

(71) Applicant: Kabushiki Kaisha Kobe Seiko Sho (Kobe Steel, Ltd.), Kobe-shi (JP)

(72) Inventors: Junichi KAWATA, Fujisawa-shi (JP); Takeshi YANO, Fujisawa-shi (JP)

(73) Assignee: Kabushiki Kaisha Kobe Seiko Sho (Kobe Steel, Ltd.), Kobe-shi (JP)

(21) Appl. No.: 19/145,967

(22) PCT Filed: Feb. 15, 2024
(86) PCT No.: PCT/JP2024/005304

§ 371 Date: Jul. 7, 2025

(30) Foreign Application Priority Data
Apr. 14, 2023 (JP) 2023-066550

(51) Int. Cl. B23K 9/095; B23K 31/12

(52) U.S. Cl. CPC B23K 9/095; B23K 31/125

(57) ABSTRACT

A welding control method controls a welding condition on the basis of a welding image acquired during welding. The method includes: an acquisition step for acquiring at least a gap width at a predetermined time interval on the basis of the welding image; a target value determination step for determining a target value of molten pool information related to a welding proceeding direction on the basis of the gap width; a difference value calculation step for calculating a difference value between a calculated value of the molten pool information related to the welding proceeding direction and the target value; and a correction step for correcting at least one of setting values of welding conditions on the basis of the difference value.

### TECHNICAL FIELD

The present invention relates to a welding control method, a welding system, and a welding control program that use a welding image.

### BACKGROUND ART

In automatic welding across various manufacturing fields such as shipbuilding, bridge construction, and architecture, there is a demand for achieving high welding quality, that is, being free from welding defects and favorable bead shapes, even in so-called “difficult welding”, such as welding in challenging positions including horizontal and vertical positions and cases where a root gap, a backing gap, or misalignment varies. As an automatic welding technique for achieving high welding quality even in difficult welding, a method for controlling welding on a basis of a welding image using a visual sensor is known.

PTL 1 addresses a problem of providing an automatic welding system capable of maintaining a welding torch at an appropriate position relative to a molten pool in horizontal welding and discloses, as a solution, a welding system including a welding robot that performs arc welding while alternately weaving a welding torch in, when a welding proceeding direction is defined as a forward direction, a forward-downward direction and a backward-upward direction along a groove extending in a horizontal direction between two welding target members arranged in a vertical direction, a camera that captures an image of an arc and a molten pool generated in the groove through the arc welding, a detection unit that detects a position of a tip of the molten pool in the camera image captured by the camera, and a determination unit that determines the amount of correction of welding speed on the basis of a distance between the arc and the tip of the molten pool when the distance falls within a predetermined range.

In addition, PTL 2 addresses a problem of stably achieving a favorable bead shape and bead quality even when a root gap, a backing gap, or misalignment varies, and, as a solution, images of left and right ends of torch weaving are extracted from an image of a molten pool of welding target members and its vicinity captured by a visual sensor, a composite image including a virtual molten pool image is generated by combining the extracted images of the left and right ends, a distance between a left end point and a right end point of the virtual molten pool image is calculated as a weaving width feature value, and tracking (adaptive) control of a torch weaving pattern is performed in accordance with variations in groove width. In addition, a distance from a center point at a tip of an electrode image to a midpoint between the left end point and the right end point of the virtual molten pool image is calculated as a weaving center feature value, and groove centerline tracking control is performed using the calculated weaving center feature value.

### CITATION LIST

### Patent Literature

PTL 1: Japanese Unexamined Patent Application Publication No. 2021-079444
PTL 2: Japanese Unexamined Patent Application Publication No. 2007-185700

### SUMMARY OF INVENTION

### Technical Problem

Changes in welding conditions, a weaving pattern, a welding position, a root gap, a backing gap, and misalignment, however, can significantly affect behavior of a molten pool, requiring adjustments to a control method according to an assumed situation. A welding control formula for a horizontal position is provided in PTL 1, but a change in the welding position, the weaving pattern, or the root gap can alter a shape of a molten pool, which makes appropriate welding control difficult and potentially impairs welding quality. In addition, PTL 2 allows for appropriate welding control regarding the root gap, the backing gap, and the misalignment, but if the welding position changes, it is highly likely that proper welding control will no longer be achievable.

As described above, a robust control method capable of maintaining stable welding quality even when various factors including the welding conditions, the weaving pattern (hereinafter also referred to as a weaving method), the welding position, the root gap, the backing gap, and the misalignment are combined is desired.

The present invention, therefore, is conceived in view of the above problems, and an object thereof is to provide a robust welding control method, a robust welding system, and a robust welding control program capable of maintaining stable welding quality in any situation in welding control that uses a welding image.

### Solution to Problem

The present invention has the following configurations.
(1) A welding control method for controlling welding conditions on a basis of a welding image obtained during welding, the welding control method including:
an obtaining step of obtaining at least a gap width at predetermined time intervals on a basis of the welding image;
a target value determination step of determining a target value of molten pool information relating to a welding proceeding direction on a basis of the gap width;
a difference value calculation step of calculating a difference value between a calculated value of the molten pool information relating to the welding proceeding direction and the target value; and
a correction step of correcting at least one of setting values of the welding conditions on a basis of the difference value.
(2) A welding system including at least:
a welding robot;
a robot control apparatus; and
an imaging apparatus,
in which the imaging apparatus captures a welding image during welding performed by the welding robot,
in which the robot control apparatus obtains at least a gap width at predetermined time intervals on a basis of the welding image,
in which a target value of molten pool information relating to a welding proceeding direction is determined on a basis of the gap width,
in which a difference value between a calculated value of the molten pool information relating to the welding proceeding direction and the target value, and
in which at least one of setting values of welding conditions is corrected on a basis of the difference value.
(3) A welding control program causing a processor included in an apparatus to achieve:
an obtaining function of obtaining at least a gap width at predetermined time intervals on a basis of a welding image obtained during welding;
a target value determination function of determining a target value of molten pool information relating to a welding proceeding direction on a basis of the gap width;
a difference value calculation function of calculating a difference value between a calculated value of the molten pool information relating to the welding proceeding direction and the target value; and
a correction function of correcting at least one of setting values of welding conditions on a basis of the difference value.

### Advantageous Effects of Invention

According to the present invention, stable welding quality can be maintained in any situation in welding control that uses a welding image.

### BRIEF DESCRIPTION OF DRAWINGS

FIG. 1 is a schematic diagram illustrating a configuration example of a welding system according to the present embodiment.

FIG. 2 is a flowchart illustrating an example of a welding control method according to the present embodiment.

FIG. 3 is a perspective view illustrating a position at which an imaging apparatus is disposed according to the present embodiment.

FIG. 4 is a diagram illustrating a welding image captured by the imaging apparatus in the case of welding in a horizontal position.

FIG. 5 is a block diagram illustrating a configuration example of a data processing apparatus according to the present embodiment.

FIG. 6 is an explanatory diagram illustrating an example of a screen used for specification work.

FIG. 7 is an explanatory diagram illustrating a specific example of a welding image obtained through welding in a horizontal position and an example of welding information in the welding image.

FIG. 8 is a conceptual diagram illustrating an example of information included in a database according to the present embodiment.

FIG. 9 is a conceptual diagram illustrating an example of a pitch.

FIG. 10 is a conceptual diagram illustrating an example of an offset value.

FIG. 11 is a flowchart illustrating an example of a process for correcting welding speed according to the present embodiment.

FIG. 12 is a graph illustrating an example of control of welding conditions according to the present embodiment.

### DESCRIPTION OF EMBODIMENTS

A welding system according to an embodiment of the present invention will be described hereinafter with reference to the drawings. Note that, in the drawings, the same components are given the same reference numerals to indicate correspondences. The welding system in the present invention is suitable for a mobile welding robot, and is not limited to the configuration in the present embodiment. For example, a six-axis welding robot or an automatic welding apparatus including a drive unit such as a mobile base may be implemented. In addition, although one-side welding in a horizontal position is selected in the present embodiment as an example, an execution method and a welding position are not limited to these, and any execution method and any welding position may be employed.

In addition, in the present embodiment, as described later, imaging is performed such that image data includes at least a molten pool during welding, and feature points relating to the molten pool, a welding wire, and an arc are extracted. A method for extracting the feature points is not particularly limited, but in the present embodiment, the feature points are extracted using a learning apparatus, which will be described later.

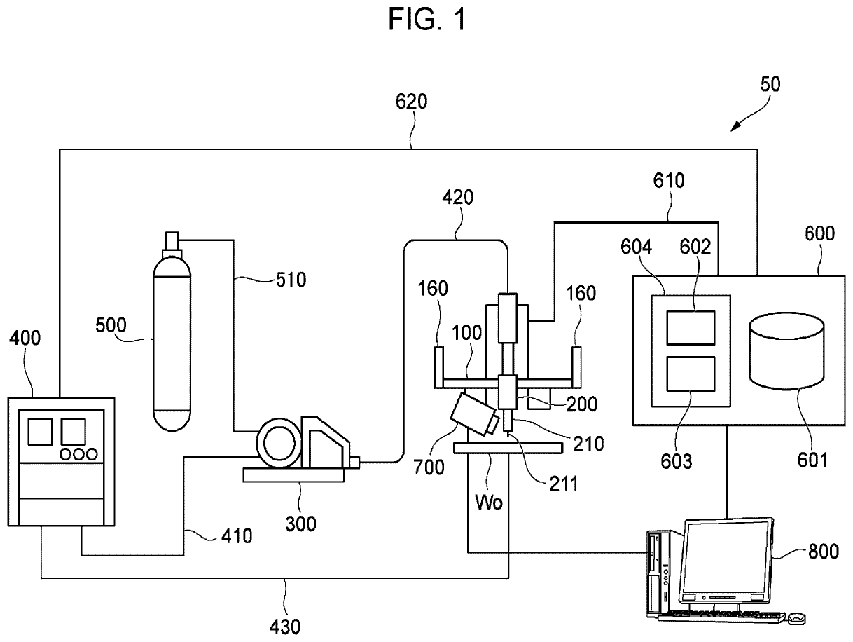

FIG. 1 is a schematic diagram illustrating a configuration example of a welding system according to the present embodiment. A welding system 50 includes a mobile welding robot 100, a feeding apparatus 300, a welding power supply 400, a shielding gas supply source 500, a robot control apparatus 600, an imaging apparatus 700, and a data processing apparatus 800. Note that, as described above, when features of the present embodiment are applied to a six-axis welding robot or an automatic welding apparatus including a drive unit such as a mobile base, additional components may also be included in accordance with the employed configuration. In addition, the components of the welding system 50 are communicably connected to one another by one of various wired or wireless communication methods. Here, the number of communication methods employed is not limited to one, and a plurality of communication methods may be combined for the connection.

### (Robot Control Apparatus)

The robot control apparatus 600 is connected to the mobile welding robot 100 by a robot control cable 610 and to the welding power supply 400 by a power supply control cable 620. The robot control apparatus 600 includes a data holding unit 601 that holds in advance teaching data in which operation patterns, welding start positions, welding end positions, execution conditions, welding conditions, and the like are defined for the mobile welding robot 100, transmits instruction information to the mobile welding robot 100 and the welding power supply 400 as a command on the basis of the teaching data to control an operation and welding conditions of the mobile welding robot 100.

The robot control apparatus 600 may also include a groove shape information calculation section 602 that calculates groove shape information from detection data obtained by performing sensing such as touch sensing before welding and a welding condition obtaining section 603 that corrects and obtains welding conditions in the teaching data on the basis of the groove shape information. The groove shape information calculation section 602 and the welding condition obtaining section 603 together form a control unit 604. The control unit 604 is achieved by, for example, a CPU (central processing unit), an MPU (micro processing unit), a DSP (digital signal processor), or an FPGA (field programmable gate array).

The robot control apparatus 600 starts welding under welding conditions in the teaching data corrected through the sensing. The imaging apparatus 700 performs imaging in such a way as to include a molten pool during the welding in image data. The data processing apparatus 800 obtains the obtained image data and extracts feature points. The robot control apparatus 600 then receives correction signals for various types of processing from information regarding the feature points as instruction information (hereinafter referred to as a command) (S1). The robot control apparatus 600 sequentially performs control including gap processing (S2), rod manipulation processing (S3), tracking and weaving width processing (S4), and speed processing (S5), each of which will be described later. The robot control apparatus 600 performs processing of the control in accordance with the correction signals received during the welding, and then outputs information regarding status update of various control conditions to the data processing apparatus 800 (S6). The above processing (S1 to S6) is repeated until the intended welding is completed (S7).

The welding power supply 400 supplies power to a welding wire 211, which is a consumable electrode, and a workpiece Wo in response to the command from the robot control apparatus 600 to generate an arc between the welding wire 211 and the workpiece Wo. The power from the welding power supply 400 is sent to the feeding apparatus 300 through a power cable 410, and sent from the feeding apparatus 300 to a welding torch (hereinafter referred to as a “torch”) 200 through a conduit tube 420. The power from the welding power supply 400 is then supplied to the welding wire 211 through a contact tip at a tip of the torch 200. Note that a current during welding work may be a direct current or an alternating current, and a waveform thereof is not particularly limited. The current, therefore, may be a pulsed current, such as square waves or triangular waves.

In addition, in the welding power supply 400, for example, the power cable 410 is connected to a torch 200 side as a positive electrode, and a power cable 430 is connected to the workpiece Wo as a negative electrode. Note that this is a case where welding is performed with reverse polarity, and when welding is performed with straight polarity, a power cable as a positive electrode may be connected to a workpiece Wo side, and a power cable as a negative electrode may be connected to the torch 200 side.

### (Shielding Gas Supply Source)

The shielding gas supply source 500 includes a container containing shielding gas and auxiliary members including a valve. The shielding gas supply source 500 sends the shielding gas to the feeding apparatus 300 through a gas tube 510. The shielding gas sent to the feeding apparatus 300 is then sent to the torch 200 through the conduit tube 420. The shielding gas sent to the torch 200 flows through the torch 200, is guided by a nozzle 210, and is ejected from a tip side of the torch 200. The shielding gas used in the present embodiment may be, for example, argon (Ar), carbon dioxide (CO2), or a mixture of these gases.

In the conduit tube 420 according to the present embodiment, a conductive path for functioning as a power cable is formed on an outer surface of the tube, and a protective conduit for protecting the welding wire 211 is provided inside the tube to form a path of the shielding gas. The conduit tube 420, however, is not limited to this, and, for example, a bundled assembly including a protective conduit for feeding the welding wire 211 to the torch 200 at the center surrounded by a power supply cable and a shielding gas supply hose may be used, instead. Alternatively, for example, the welding wire 211 and the tube for sending the shielding gas may be provided separately from the power cable.

### (Feeding Apparatus)

The feeding apparatus 300 feeds the welding wire 211 to the torch 200. The welding wire 211 fed by the feeding apparatus 300 is not particularly limited and selected on the basis of characteristics of the workpiece Wo, a welding mode, or the like, and, for example, solid wire or flux-cored wire is used. In addition, diameter of the welding wire is not particularly limited, but a desirable diameter in the present embodiment is 1.6 mm at maximum and 0.9 mm at minimum.

In addition, in the present embodiment, a voltage is applied between the workpiece Wo and the welding wire 211, and a touch sensor that senses a surface of a groove 10 or the like illustrated in FIG. 3 serves as detection means using a voltage drop phenomenon caused when the welding wire 211 comes into contact with the workpiece Wo. The detection means is not limited to the touch sensor in the present embodiment, and an image sensor, a laser sensor, or the like, or a combination of these detection means may be used, but the touch sensor in the present embodiment is preferably used from the viewpoint of simplifying apparatus configuration.

### (Imaging Apparatus)

The imaging apparatus 700 (hereinafter also referred to as a “visual sensor” or a “camera”) is achieved by, for example, a camera including a CCD (charge coupled device) as a visual sensor. A position at which the imaging apparatus 700 is disposed is not particularly limited, and the imaging apparatus 700 may be directly attached to the mobile welding robot 100 or fixed at a specific nearby location as a monitoring camera. When the mobile welding robot 100 is directly attached to the imaging apparatus 700, the imaging apparatus 700 moves in such a way as to capture an image of an area around the tip of the torch 200 in accordance with an operation of the mobile welding robot 100. A plurality of cameras may be provided for the imaging apparatus 700. For example, the imaging apparatus 700 may include a plurality of cameras whose functions and locations are different from one another.

In addition, a direction in which the imaging apparatus 700 performs imaging is not particularly limited. For example, when a direction in which welding proceeds is defined as a forward direction, the imaging apparatus 700 may be disposed in such a way as to capture an image of a scene in the forward direction, or may be disposed in such a way as to capture an image of a scene on a side or a scene in a rearward direction. An imaging range of the imaging apparatus 700, therefore, may be appropriately determined. Note that, in order to suppress interference with the torch 200, it is preferable to perform imaging from a forward side, and imaging from the forward side is performed in the present embodiment. Obtained image information is transmitted to the data processing apparatus 800 and used in the data processing apparatus 800. At this time, the data processing apparatus 800 may extract arbitrary images from the obtained image information at predetermined intervals, for example, and use the images for processing described later. An extraction method and extraction settings here may be changed in accordance with, for example, configuration and functions of the imaging apparatus 700, performance of the data processing apparatus 800, and the like.

In the present embodiment, the imaging apparatus 700 directly attached to and fixed on the mobile welding robot 100 is used to capture a moving image as a welding image such that the imaging range includes at least the workpiece Wo, the welding wire 211, and the arc as objects (targets) to be included in the image data. Note that various imaging settings relating to the welding image may be specified in advance or changed in accordance with operation conditions of the welding system 50. The imaging settings include, for example, a frame rate, the number of image pixels, resolution, and shutter speed.

FIG. 3 is a perspective view illustrating the position at which the imaging apparatus 700 is disposed according to the present embodiment. Note that directions of the torch 200 and the groove differ depending on the welding position, and directions illustrated in FIG. 3 are examples. In the present embodiment, the workpiece Wo is a butt joint. The workpiece Wo is two metal plates butt-jointed to each other with a groove provided therebetween. A horizontal position is taken as an example in the present embodiment, and in this case, an upper plate of the workpiece is denoted by W1 (hereinafter referred to as an upper plate W1), and a lower plate of the workpiece is denoted by W2 (hereinafter referred to as a lower plate W2). In addition, a ceramic backing material 14 is attached to back surfaces of the two workpieces W1 and W2 butt-jointed to each other. Note that a metal backing material may be used as the backing material 14, and a configuration without a backing material may be employed. A material of the backing material, therefore, is not particularly limited, and may differ depending on a material of the workpiece Wo or the like. In the case of a butt joint, arc welding is performed along a groove in one direction. In the following description, a direction in which welding proceeds will be referred to as a “welding line direction”. In FIG. 3, an arrow indicates a direction in which welding proceeds. The torch 200, therefore, is located in the rearward direction of the imaging apparatus 700.

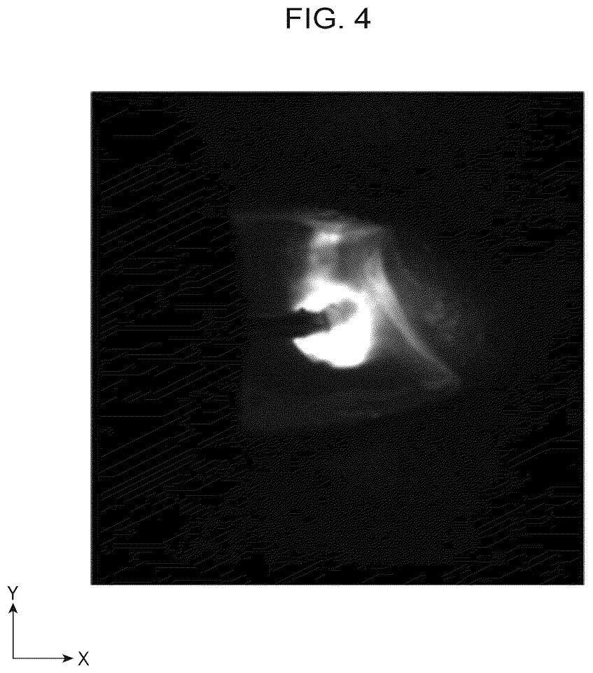

FIG. 4 is a diagram illustrating an example of a welding image captured by the imaging apparatus 700 in the case of welding in a horizontal position. Image data in FIG. 4 has coordinates on a coordinate plane defined by an X-axis and a Y-axis. In the present embodiment, in which the horizontal position is employed, the X-axis represents the welding line direction, and the Y-axis represents a direction perpendicular to the X-axis. The imaging apparatus 700 captures an image of a range including a welding position of the workpiece Wo during arc welding. The captured image includes a molten pool, the welding wire 211, and the arc.

The visual sensor of the imaging apparatus 700 in the present embodiment can continuously capture still images of, for example, 1,024×768 pixels. In other words, the imaging apparatus 700 can capture a welding image as a moving image. Resolution of still images that can be captured by the imaging apparatus 700 is not particularly limited. For example, when the imaging apparatus 700 includes a plurality of cameras, each of the plurality of cameras may obtain a welding image of a different resolution. In addition, before a welding image captured for the purpose of reducing processing time is input to a trained model, which will be described later, preprocessing such as extracting an arbitrary feature region from the welding image may be performed. The arbitrary feature region may be a range of a fixed size disposed such that a predetermined region is located at the center. In addition, the size of the arbitrary feature region may be changed in accordance with a welding situation.

### (Data Processing Apparatus)

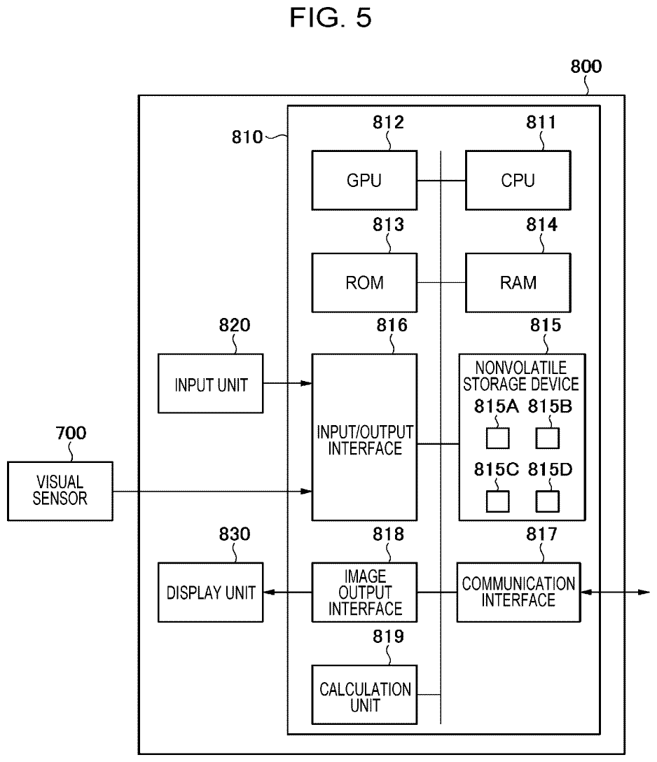

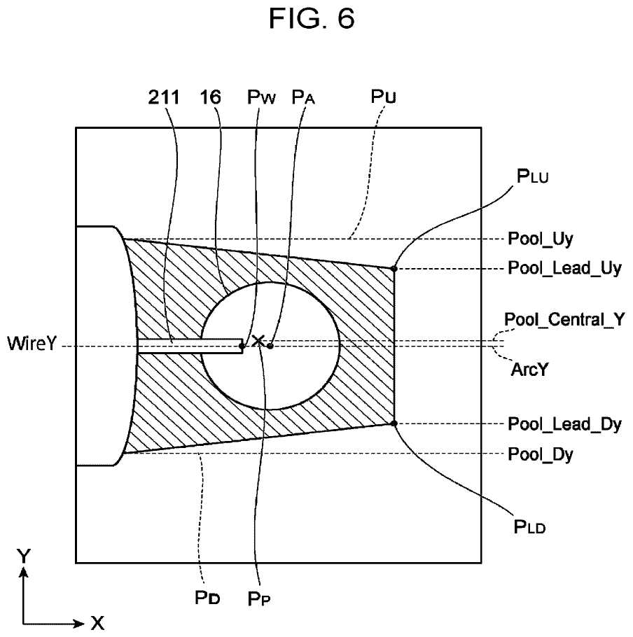

FIG. 5 is a block diagram illustrating a configuration example of the data processing apparatus 800 according to the present embodiment. The data processing apparatus 800 is achieved by, for example, a computer. The computer includes a body 810, an input unit 820, and a display unit 830. The body 810 includes a CPU 811, a GPU (graphical processing unit) 812, a ROM 813, a RAM 814, a nonvolatile storage device 815, an input/output interface 816, a communication interface 817, an image output interface 818, and a calculation unit 819. The CPU 811, the GPU 812, the ROM 813, the RAM 814, the nonvolatile storage device 815, the input/output interface 816, the communication interface 817, the image output interface 818, and the calculation unit 819 are mutually communicably connected to one another by a bus or a signal line.

The nonvolatile storage device 815 stores a learning program 815A for executing deep learning using predetermined training data, a trained model 815B generated by executing the learning program 815A, an information generation program 815C for generating welding information regarding welding using the trained model 815B, and image data 815D. In addition to these, an operating system and an application program are also installed on the nonvolatile storage device 815.

When the CPU 811 and the GPU 812 execute the programs, the data processing apparatus 800 achieves various functions. In the present embodiment, the data processing apparatus 800 achieves a function of generating a trained model through machine learning and a function of performing various types of processing during actual welding using the trained model. Details of these functions will be described later. Note that the data processing apparatus 800 may be divided in accordance with the function of generating a trained model and a function of performing control processing on the basis of information output from the trained model during execution of actual welding. From the viewpoint of versatility, it is more preferable to divide the data processing apparatus 800 in accordance with the individual functions. The GPU 812 is used as a processing device at a time when the learning program 815A and the information generation program 815C are executed. The ROM 813 stores a BIOS (basic input output system) to be executed by the CPU 811 and the like. The RAM 814 is used as a working area of a program read from the nonvolatile storage device 815.

The input/output interface 816 is connected to the input unit 820 including a keyboard and a mouse. The imaging apparatus 700, which is the visual sensor, is also connected to the input/output interface 816. Image data output from the imaging apparatus 700 is given to the CPU 811 through the input/output interface 816. The communication interface 817 is a communication module for wired or wireless communication. The image output interface 818 is connected to, for example, the display unit 830 including a liquid crystal display or an organic EL (electro-luminescence) display, and outputs, to the display unit 830, an image signal according to image data given from the CPU 811. The calculation unit 819 performs, in conjunction with the CPU 811 and the GPU 812, various types of processing including, for example, calculation of geometric quantities to be used to control welding speed according to the present embodiment. The geometric quantities will be described later.

### (Generation of Trained Model)

Feature points extracted from image data and a trained model for extracting the feature points in the present embodiment will be described hereinafter. The trained model 815B in the present embodiment is achieved by a convolutional neural network, and includes a plurality of convolutional layers and a plurality of pooling layers. Note that configuration of the convolutional neural network is not limited to the above, and the number of layers and configuration may be different.

The trained model 815B receives a welding image output from the imaging apparatus 700 as input data and outputs feature information for calculating at least a gap width and molten pool information relating to the welding proceeding direction. In the present embodiment, a captured image input to the trained model 815B shows at least a molten pool, a welding wire, and an arc as objects (targets). By inputting the captured image to the trained model 815B, feature points obtained from each of the objects and relationships between the plurality of objects are extracted. The data processing apparatus 800 obtains in real-time information such as the gap width and the molten pool information, which will be described later, as geometric quantities on the basis of the extracted feature points. Note that examples of the geometric quantities of the molten pool information include a distance between the welding wire and a tip of the molten pool in the welding line direction and width or area of the molten pool. For example, the molten pool information includes at least a distance between a predetermined position and the tip of the molten pool in the welding image or the area of the molten pool. The predetermined position may be a position of a tip of the wire or an arc center point.

In the present embodiment, the tip of the welding wire 211 (hereinafter referred to as a wire tip), a center point of the arc (hereinafter referred to as an arc center), positions of left and right (upper and lower, in the case of a horizontal position) tips of the molten pool in the welding proceeding direction, and positions of left and right (upper and lower, in the case of a horizontal position) ends of the molten pool in the welding proceeding direction are used as feature points relating to the welding information. Feature points to be used as training data are input when an operator specifies a specific position in a welding image in accordance with an instruction in an operation screen for assisting specification work. The training data, therefore, is configured with a welding image and feature points that are coordinate information as welding information specified by the operator as a pair. In learning processing, parameters are adjusted by comparing welding information output from a learning model and welding information included in the training data and feeding back errors. By repeating this processing, machine learning progresses to generate the trained model 815B.

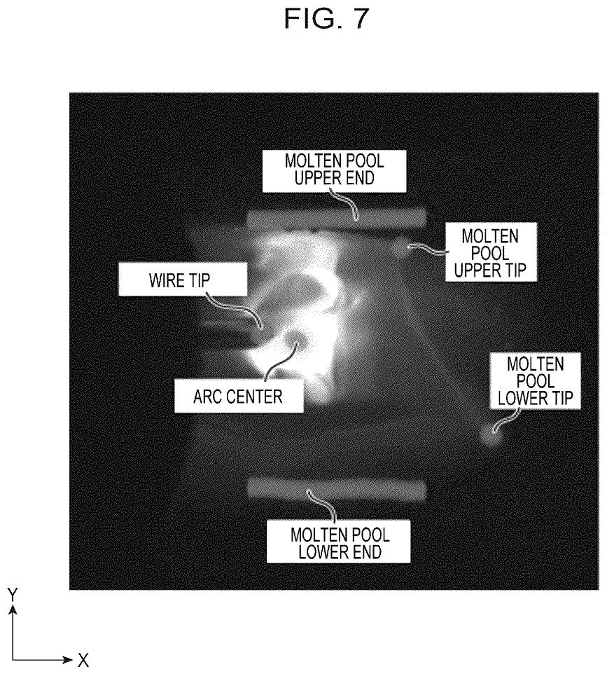

FIG. 6 is an explanatory diagram illustrating an example of a screen used for the specification work. A welding image in the screen illustrated in FIG. 6 includes a molten pool 15, the welding wire 211, and an arc 16. In FIG. 6, the molten pool 15 is hatched. FIG. 7 is an explanatory diagram illustrating a specific example of a welding image obtained through welding in a horizontal position and an example of welding information in the welding image. Here, in order to simplify description, positions corresponding to coordinates indicated by feature points are drawn on the welding image. Note that, as described above, the images have coordinates, and a coordinate plane defined by the X-axis and the Y-axis is provided. Note that, in the description with reference to FIGS. 6 and 7, an “upper end” and a “lower end” just indicate upper and lower positions in the images, and may be replaced with a “right end”, a “left end”, or the like in accordance with a welding position and a direction of the image.

Since the imaging apparatus 700 is disposed such that the welding line direction and an X-axis direction become parallel to each other in the present embodiment, the X-axis direction may also be referred to as the welding line direction. In addition, since a Y-axis direction is a direction perpendicular to the X-axis, that is, a groove width direction that is a direction perpendicular to a welding line, the Y-axis direction may also be referred to as the groove width direction. Note that since the X-axis along which the mobile robot in the present embodiment moves is the welding line direction, it can be said that the X-axis along which the mobile robot moves and the X-axis in the welding image coincide with each other and that, as for the Y-axis direction, the Y-axis along which the mobile robot moves and the Y-axis direction in the welding image coincide with each other.

In the case of the present embodiment, as illustrated in FIG. 6, the operator specifies, as feature points, a coordinate position P_{A} (ArcX, ArcY) at the arc center, a coordinate position P_{W} (WireX, WireY) at the wire tip, a coordinate position P_{LD} (Pool_Lead_Dx, Pool_Lead_Dy) at a lower tip of the molten pool, a coordinate position P_{LU} (Pool_Lead_Ux, Pool_Lead_Uy) at an upper tip of the molten pool, a coordinate position P_{D} (Pool_Dy) at a lower end of the molten pool, and a coordinate position P_{U} (Pool_Uy) at an upper end of the molten pool. The feature points are input when the operator specifies specific positions on the screen. Coordinates that give a boundary between the welding wire 211 and the arc are an example of position coordinates of the wire tip. In addition, the lower tip of the molten pool, the upper tip of the molten pool, the lower end of the molten pool, and the upper end of the molten pool are examples of feature points relating to behavior of the molten pool 15. For example, when the feature points of the lower end of the molten pool and the upper end of the molten pool are known, width of the molten pool 15 can be calculated.

### (Geometric Data)

In the present embodiment, the robot control apparatus 600 or the data processing apparatus 800 calculates at least two values, namely a difference (hereinafter referred to as “LeadX”) in the X direction between the position of the upper tip of the molten pool determined in advance and the position of the wire tip and a difference (hereinafter referred to as “LeadW”) between the upper tip of the molten pool and the lower tip of the molten pool. In the present embodiment, numerical data calculated on the basis of the feature points will be referred to as geometric data. Note that the data processing apparatus 800 calculates the geometric data and transmits the geometric data to the robot control apparatus 600 at predetermined time intervals, and the robot control apparatus performs welding control. Note that a position of a tip of the molten pool may be the position of the upper tip of the molten pool or the lower tip of the molten pool as needed for the purpose regardless of a position of the difference between the upper tip of the molten pool and the lower tip of the molten pool. In addition, the robot control apparatus 600 and the data processing apparatus 800 may be integrated together. Processing assumed to be performed by the robot control apparatus 600 may be performed by the data processing apparatus 800, and processing assumed to be performed by the data processing apparatus 800 may be performed by the robot control apparatus 600, instead, insofar as no contradiction is caused.

### <Welding Control Method>

### (Gap Processing S2)

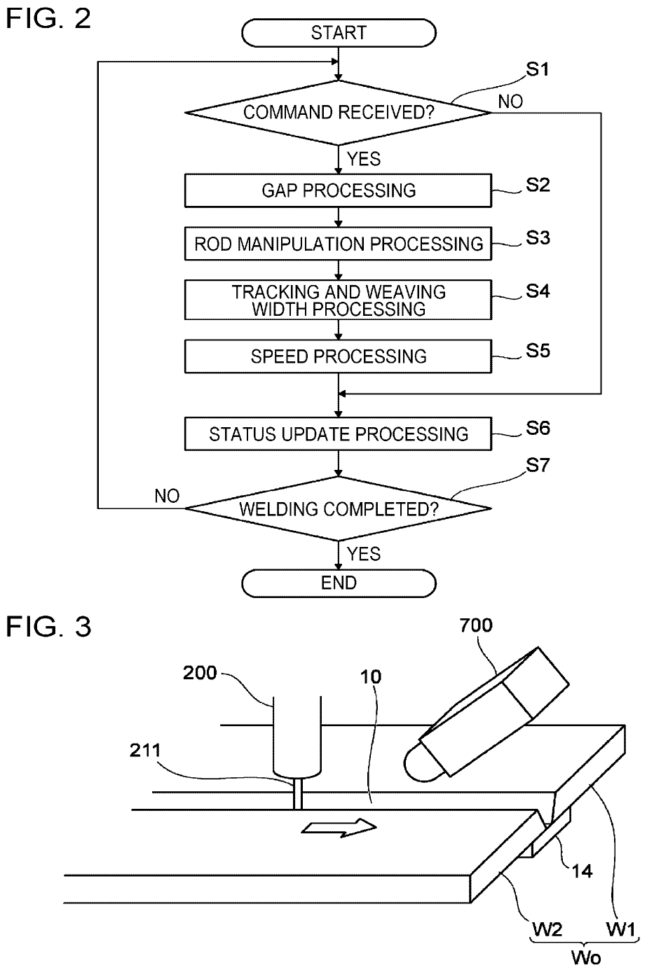

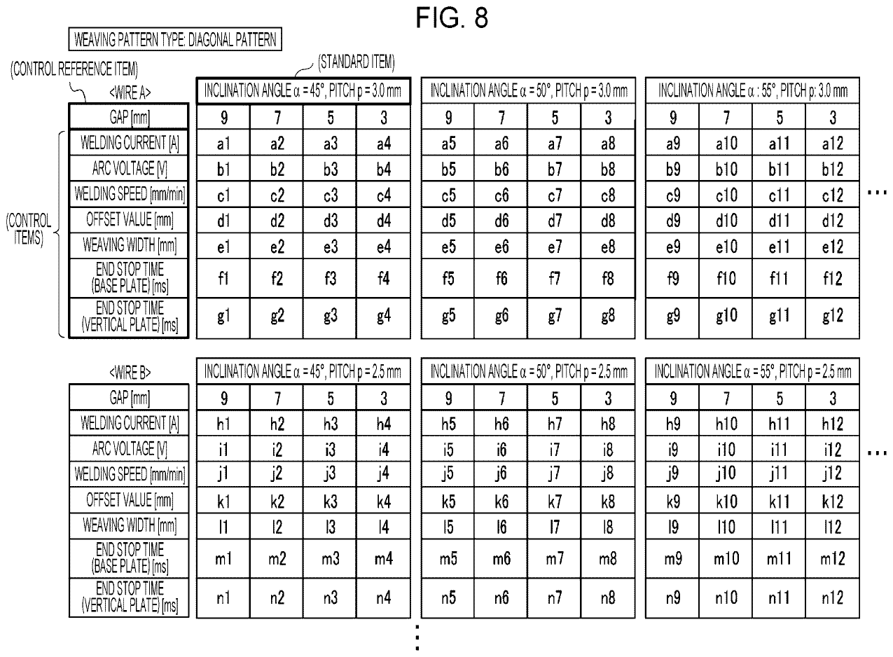

FIG. 2 is a flowchart illustrating an example of a welding control method according to the present embodiment. The robot control apparatus 600 receives information including the above-described geometric data from the data processing apparatus 800 at predetermined time intervals. The reception will be referred to as command reception hereinafter. After the command reception, the robot control apparatus 600 changes, in the gap processing S2, welding conditions in accordance with the received geometric data regarding LeadW. Here, the geometric data regarding LeadW in the present embodiment is handled as a gap value in the gap processing S2. Note that a unit of gap values is mm in the present embodiment. A method for changing welding conditions in accordance with the geometric data regarding LeadW is not particularly limited, but in the present embodiment, as illustrated in FIG. 8, a database in which welding conditions corresponding to the gap value are determined in advance for each welding mode may be prepared, and the welding conditions may be changed on the basis of the database and the received geometric data regarding LeadW. Note that the welding mode here refers to, for example, fixed conditions such as a type of wire, a type of shielding gas, an inclination angle, and a pitch. These fixed conditions are also referred to as standard items in FIG. 8. Note that the database may be stored in a storage device included in the robot control apparatus 600.

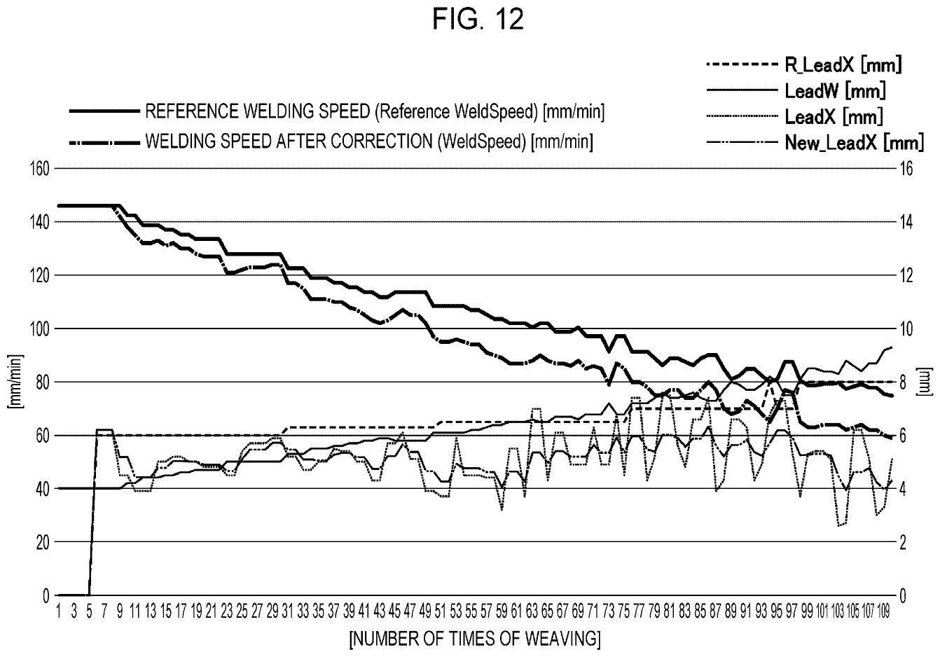

FIG. 8 is a conceptual diagram illustrating an example of information stored in the database according to the present embodiment. A case will be described with reference to FIG. 8 in which the fixed conditions as the standard items are wire A, an inclination angle α=45°, and a pitch p=3.0 mm. When the robot control apparatus 600 receives a gap value of 9 mm from the geometric data regarding LeadW during welding, the robot control apparatus 600 changes the welding conditions to a welding current al, an arc voltage b1, a welding speed c1, an offset value d1, a weaving width e1, an end stop time (lower end) f1, and an end stop time (upper end) g1. The welding speed c1 corresponds to a reference welding speed (Reference WeldSpeed) in FIG. 12, which will be described later. The end stop time (lower end) f1 and the end stop time (upper end) g1 will be together referred to as a weaving end stop period.

Note that the inclination angle and the pitch in the fixed conditions that are the standard items and the offset value in the welding conditions to be changed are items unique to the mobile welding robot used in the present embodiment, and other items are used when a six-axis robot is employed. The types of fixed conditions and the types of control items determined in advance in the database in accordance with the fixed conditions illustrated in FIG. 8 are examples, and those skilled in the art may appropriately set the types in accordance with a type of welding to be performed or the like.

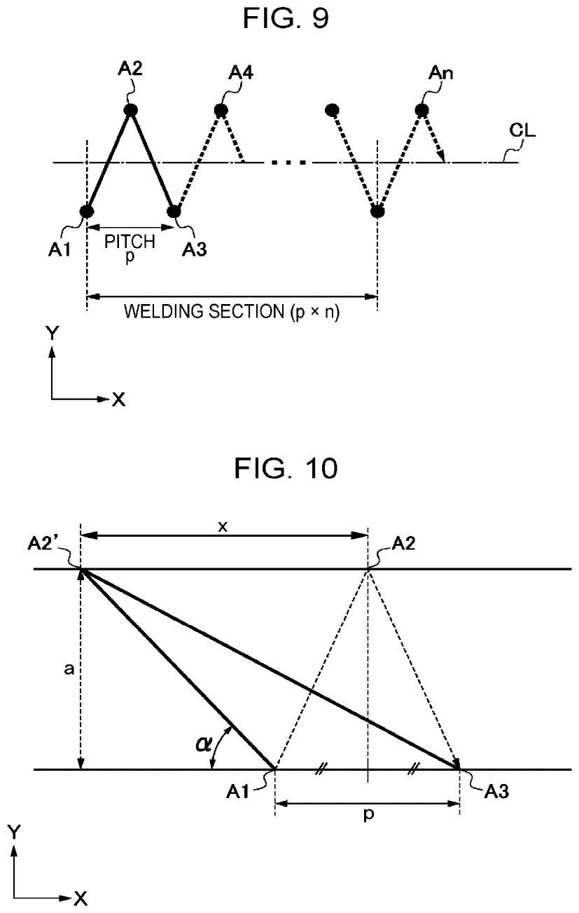

FIG. 9 is a conceptual diagram illustrating the pitch. As illustrated in FIG. 9, the pitch refers to a distance traveled in one weaving motion, and is a setting value necessary to determine a weaving method of the mobile welding robot. It is therefore preferable to include the pitch in the fixed conditions. In general, other weaving conditions such as the welding speed, the weaving width, and the end stop times are determined on the basis of the setting value of the pitch p. In addition, the offset value is a condition for changing a weaving pattern. By changing a direction and a distance of at least one predetermined point in one cycle of weaving as the “offset value”, weaving of various patterns can be performed. FIG. 10 is a conceptual diagram illustrating an example of the offset value. By changing a position A2 to a position A2′ as illustrated in FIG. 10, for example, weaving of a special pattern can be achieved. At this time, the offset value is a value x in FIG. 10. In addition, when the weaving follows a diagonal pattern as illustrated in the drawing, it is preferable to set the inclination angle α as a fixed condition in advance and extract the offset value x corresponding to the inclination angle α and other setting values.

### (Rod Manipulation Processing S3)

FIG. 2 will be referred to again. In the rob manipulation processing S3, the robot control apparatus 600 determines a method for manipulating a rod on the basis of the information received thereby through the command reception and information regarding the preprocessing such as the gap processing S2. The rod manipulation is also called weaving. In the present embodiment, the robot control apparatus 600 determines the weaving method on the basis of the conditions such as the offset value, the weaving width, the end stop time (lower end), and the end stop time (upper end) determined in the gap processing S2.

### (Tracking and Weaving Width Processing S4)

In the tracking and weaving width processing S4, the robot control apparatus 600 performs welding line tracking and width tracking on the basis of the information received thereby through the command reception and the information regarding the preprocessing. A tracking method is not limited, but in the present embodiment, welding line tracking control is performed in accordance with a deviation direction (when the horizontal position in the present embodiment is taken as an example, determines whether deviation is upward or downward) and a deviation amount from a welding center position, which is a center position of LeadW, calculated on the basis of a difference between the welding center position and a position of the upper tip of the molten pool and a difference between the welding center position and a position of the lower tip of the molten pool. In addition, width tracking control is performed by calculating the amount of correction of the weaving width in accordance with the value of LeadW.

### (Speed Processing S5)

In the present invention, the conditions set in accordance with a gap are further corrected. As a result of this correction process, accuracy of the control further improves, and stable welding quality can be maintained even when various factors including the welding conditions, the weaving method, the welding position, a root gap, a backing gap, and misalignment are combined. In other words, a robust welding control method can be achieved where stable welding quality can be maintained in any situation. The conditions to be corrected may include one of the welding speed, the welding current, an arc voltage, a wire extension, and the like, but it is preferable to correct at least the welding speed from the viewpoint of ease and the accuracy of the control. In the present embodiment, a case where the welding speed is corrected (speed processing S5) will be described.

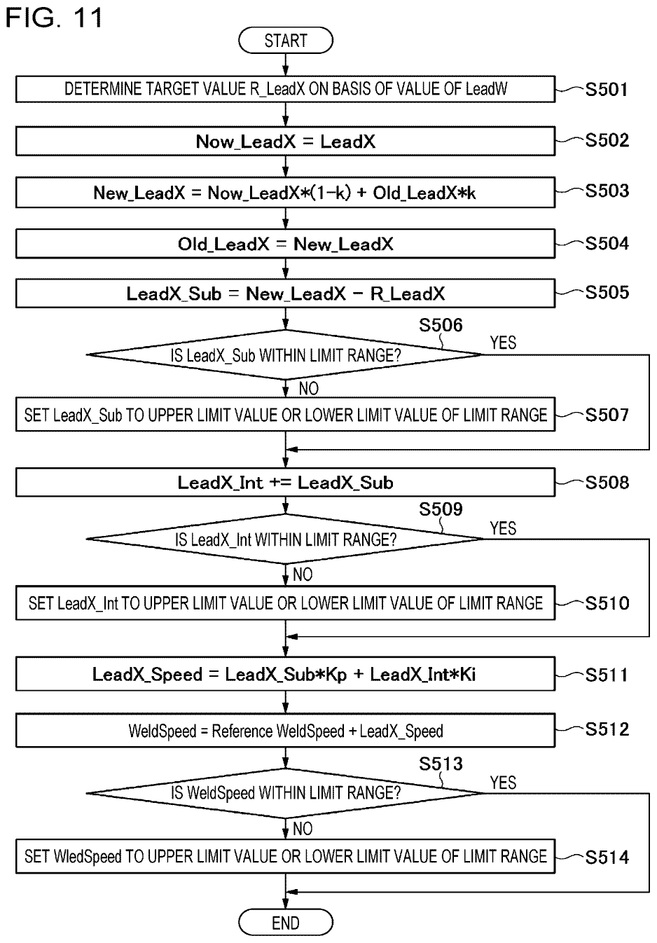

FIG. 11 is a flowchart illustrating an example of the process for correcting the welding speed according to the present embodiment. In the present embodiment, in the speed processing S5 illustrated in FIG. 2, the amount of correction of the welding speed is calculated using the value of gap width obtained through the command reception and LeadX, which is a piece of the molten pool information relating to the welding proceeding direction. Note that in the speed processing S5 according to the present embodiment, LeadW is used as the value of gap width. In addition, although LeadX is used as the molten pool information relating to the welding proceeding direction in the present embodiment, for example, another piece of the geometric data such as the area of the molten pool may be used, instead.

### (Determination of Target Value of LeadX)

In step S501, the robot control apparatus 600 determines a target value R_LeadX of LeadX on the basis of LeadW received through the command reception. It is specified in advance that, for example, R_LeadX be a value of 1 when LeadW is smaller than or equal to 7.0 mm, R_LeadX be a value of 2 when LeadW is larger than 7.0 mm and smaller than or equal to 8.0 mm, R_LeadX be a value of 3 when Leadw is larger than 8.0 mm and smaller than or equal to 9.0 mm. 7.0 mm, 8.0 mm, and 9.0 mm here are predetermined thresholds. That is, the robot control apparatus 600 determines the target value R_LeadX of the molten pool information relating to the welding proceeding direction on the basis of the gap width LeadW and the predetermined thresholds. Note that a table that defines correspondences between LeadW and R_LeadX may be saved in the robot control apparatus 600 in advance, and the robot control apparatus 600 may refer to this table and determine the target value R_LeadX from the gap width LeadW.

### (Calculation of Difference Value)

In steps S502 to S505, the robot control apparatus 600 calculates a difference value LeadX_Sub between the real-time LeadX received through the command reception and the target value R_LeadX. That is, a calculated value of the molten pool information relating to the welding proceeding direction in the present embodiment is LeadX, New_LeadX, which will be described later, or the like. The robot control apparatus 600 calculates the difference value between the calculated value of the molten pool information relating to the welding proceeding direction and the target value.

Note that if the correction is performed with an unexpected value due to an effect of disturbance or the like, the control might not be appropriately performed. In order to avoid the effect of disturbance, the robot control apparatus 600 may employ, in steps S502 to S504, a moving average of a current value of LeadX and past values of LeadX.

In the present embodiment, as indicated by Expression (2), a moving average “New_LeadX” is employed, and the difference value “LeadX_Sub” between “New_LeadX” and “R_LeadX” is calculated. Note that a value calculated as “New_LeadX” is stored as “Old_LeadX” before “Now_LeadX” is newly received, and used to calculate a next moving average.

New_LeadX=Now_LeadX*(1−k)+Old_LeadX*k (Expression 1)
(k is a variable of 0 to 1)

LeadXSub=New_LeadX−R_LeadX (Expression 2)

That is, the robot control apparatus 600 may calculate the calculated value New_LeadX of the molten pool information relating to the welding proceeding direction as a moving average of two or more calculated values Now_LeadX and Old_LeadX of molten pool information regarding two or more welding images captured at successive timings.

### (Application of First Limiter)

It is preferable to apply a limiter to the difference value LeadX_Sub from the viewpoint of stabilizing the control. If the difference value LeadX_Sub exceeds a limit range, a maximum value or a minimum value of the limit range is used as the difference value LeadX_Sub. It is assumed, for example, that the limit range of the difference value LeadX_Sub is +α mm to −α mm and that α is an arbitrary threshold. This α will also be referred to as a predetermined first threshold. If the difference value LeadX_Sub exceeds the limit range on a positive side, the difference value LeadX_Sub becomes α mm, which is a fixed value, and if the difference value LeadX_Sub exceeds the limit range on a negative side, the difference value LeadX_Sub becomes −α mm, which is a fixed value. Steps S506 and S507 in FIG. 11 are processing for applying this first limiter, and the robot control apparatus 600 performs the processing.

Note that if the difference value LeadX_Sub is a value outside the range of +α mm to −α mm defined by the first threshold α, the robot control apparatus 600 may perform one of the following four types of processing.
Sets the difference value to a predetermined value (e.g., an upper limit value or a lower limit value).
Does not perform a correction step based on the difference value.
Outputs a signal indicating that the value is outside the range.
Stops the robot control apparatus 600.

In step S508, the robot control apparatus 600 calculates an integral value LeadX_Int of the difference value LeadX_Sub.

### (Application of Second Limiter)

It is preferable to apply a limiter also to the integral value LeadX_Int from the viewpoint of stabilizing the control. If the integral value LeadX_Int exceeds a limit range, a maximum value or a minimum value of the limit range is used as the integral value LeadX_Int. It is assumed, for example, that the limit range of the integral value LeadX_Int is +β mm to −β mm and that β is an arbitrary value. This β will also be referred to as a predetermined second threshold. If the integral value LeadX_Int exceeds the limit range on a positive side, the integral value LeadX_Int becomes β mm, which is a fixed value, and if the integral value LeadX_Int exceeds the limit range on a negative side, the integral value LeadX_Int becomes −β mm, which is a fixed value. Steps S509 and S510 in FIG. 11 are processing for applying this second limiter, and the robot control apparatus 600 performs the processing.

Note that if the integral value LeadX_Int is a value outside the range +β mm to −β mm defined by the second threshold β, the robot control apparatus 600 may perform one of the following four types of processing.
Sets an integral value to a predetermined value (e.g., an upper limit value or a lower limit value).
Does not perform a correction step based on the integral value.
Outputs a signal indicating that the value is outside the range.
Stops the robot control apparatus 600.

### (PI Control)

The amount of correction for controlling the welding speed is denoted by LeadX_Speed. A unit of LeadX_Speed is mm/min. As indicated by Expression 3, LeadX_Speed is preferably calculated through PI control including a term obtained by multiplying the difference value LeadX_Sub by an arbitrary first coefficient Kp and a term obtained by multiplying the integral value LeadX_Int by an arbitrary second coefficient Ki. The robot control apparatus 600 calculates the amount of correction LeadX_Speed (S511).

LeadX_Speed=LeadX_Sub*Kp+LeadX_Int*Ki (Expression 3)

(Welding Speed Value Condition after Correction)

As indicated by Expression 4, the robot control apparatus 600 calculates a value WeldSpeed of welding speed after the correction by adding LeadX_Speed to Reference WeldSpeed, which is a welding speed condition set in accordance with the gap (S512).

WeldSpeed=Reference WeldSpeed+LeadX_Speed (Expression 4)

### (Application of Third Limiter)

Note that it is preferable to apply a limiter also to the value WeldSpeed of welding speed after the correction from the viewpoint of stabilizing the control. If WeldSpeed exceeds a limit range, the robot control apparatus 600 sets WeldSpeed to a maximum value or a minimum value of the limit range. Steps S513 and S514 in FIG. 11 are processing for applying this limit value, and the robot control apparatus 600 performs the processing.

As indicated by Expressions 5 and 6, for example, an upper limit value and a lower limit value may be determined by multiplying Reference WeldSpeed by coefficients.

Lower limit value=Reference WeldSpeed*M1 (Expression 5)

Upper limit value=Reference WeldSpeed*M2 (Expression 6)

M1 and M2 are arbitrary coefficients that satisfy M1≤M2. Reference WeldSpeed*M1 is a third threshold that defines a lower limit of a setting value of a welding condition. Reference WeldSpeed*M2 is a fourth threshold that defines an upper limit of the setting value of the welding condition.

Note that if the setting value of the welding condition is a value outside a range defined by the third and fourth thresholds, the robot control apparatus 600 may perform one of the following four types of processing.
Sets the setting value of the welding condition to a predetermined value (e.g., an upper limit value or a lower limit value).
Does not perform the correction step of correcting to the setting value of the welding condition.
Outputs a signal indicating that the value is outside the range.
Stops the robot control apparatus 600.

The robot control apparatus 600 then changes the condition of the welding speed to the value WeldSpeed, which is a calculated value. That is, the robot control apparatus 600 corrects the welding speed, which is at least one of the setting values of the welding conditions on the basis of the difference value LeadX_Sub.

### (Status Update S6)

The robot control apparatus 600 transmits instruction values to the mobile welding robot 100 and the welding power supply 400 in accordance with the welding conditions changed through the above-described process. As described above, the processing in steps S1 to S6 in FIG. 2 is repeated until the welding is completed.

FIG. 12 is a graph illustrating an example of the control of the welding conditions according to the present embodiment. A horizontal axis of the graph represents the number of times of weaving. One time of weaving is one cycle of weaving. That is, data is obtained at time intervals according to a weaving cycle. Although the number of times of weaving is employed as the predetermined time intervals, the predetermined time intervals are not limited to this, and, for example, data may be obtained at predetermined times. In the graph, the reference welding speed (Reference WeldSpeed), the welding speed (WeldSpeed) corrected in step S5 described above, LeadW, LeadX, R_LeadX, and New_LeadX are described. In addition, in FIG. 12, the reference welding speed and the welding speed after the correction are represented by a left vertical axis of the graph, and LeadW, LeadX, R_LeadX, and New_LeadX are represented by a right vertical axis of the graph.

As can be seen from the graph, the reference welding speed (Reference WeldSpeed) determined in step S2 from the database on the basis of the value of LeadW is corrected to the welding speed WeldSpeed by performing the processing in step S5.

The value of LeadW corresponding to the gap tends to increase over time. The target value R_LeadX determined in step S501 varies on the basis of the value of LeadW.

As the value of LeadW increases, the value of LeadX, which is an instantaneous value, fluctuates wildly as shown in the graph. The value of New_LeadX, which is a filtered moving average of LeadX obtained in step S503, however, does not fluctuate significantly, and is more stable as a value to be used for the control. WeldSpeed after the correction is determined in step S512 on the basis of the difference value LeadX_Sub between this more stable New_LeadX and the target value R_LeadX.

As described above, the present specification discloses the following items.
(1) A welding control method for controlling welding conditions on a basis of a welding image obtained during welding, the welding control method including:
an obtaining step of obtaining at least a gap width at predetermined time intervals on a basis of the welding image;
a target value determination step of determining a target value of molten pool information relating to a welding proceeding direction on a basis of the gap width;
a difference value calculation step of calculating a difference value between a calculated value of the molten pool information relating to the welding proceeding direction and the target value; and
a correction step of correcting at least one of setting values of the welding conditions on a basis of the difference value.

With this welding control method, stable welding quality can be maintained in any situation in welding control that uses a welding image.
(2) The welding control method according to (1), further including:
a changing step of changing the setting values of the welding conditions on a basis of the gap width,
in which the setting values of the welding conditions to be changed in the changing step include at least one of a welding current, an arc voltage, a welding speed, an offset value, a weaving width, and a weaving end stop period.

With this welding control method, more stable welding quality can be maintained by changing at least one of the welding current, the arc voltage, the welding speed, the offset value, the weaving width, and the weaving end stop period and performing the correction step.
(3) The welding control method according to (2),
in which the setting values of the welding conditions to be changed in the changing step are obtained on a basis of a database storing the gap width and relationships between the gap width and the setting values of the welding conditions for each of predetermined standard items.

With this welding control method, the setting values of the welding conditions can be easily changed while referring to the database.
(4) The welding control method according to any of (1) to (3),
in which the setting values of the welding conditions to be corrected in the correction step include at least the welding speed.

With this welding control method, accuracy of welding can be improved through relatively easy control.
(5) The welding control method according to any of (1) to (3), further including:
a step of applying a first limit to the difference value on a basis of a predetermined first threshold.

With this welding control method, the control can be stabilized even when the difference value becomes an extreme value.
(6) The welding control method according to any of (1) to (3),
in which, in the correction step, at least one of the setting values of the welding conditions is corrected on a basis of a calculation formula including at least a term obtained by multiplying the difference value by a predetermined first coefficient and a term obtained by multiplying an integral value of the difference value by a predetermined second coefficient.

With this welding control method, PI control can be stably performed.
(7) The welding control method according to (6), further including:
a step of applying a second limiter to the integral value on a basis of a predetermined second threshold.

With this welding control method, the control can be stabilized even when the integral value becomes an extreme value.
(8) The welding control method according to any of (1) to (3), further including:
a step of applying a third limiter to the welding condition corrected in the correction step on a basis of a predetermined third threshold and a predetermined fourth threshold,
in which the third threshold is a value that defines a lower limit of the setting value of the welding condition, and
in which the fourth threshold is a value that defines an upper limit of the setting value of the welding condition.

With this welding control method, the control can be stabilized even when the corrected welding condition becomes an extreme value.
(9) The welding control method according to any of (1) to (3), further including:
a step of calculating the calculated value of the molten pool information relating to the welding proceeding direction as a moving average of two or more calculated values of molten pool information regarding the two or more welding image captured at successive timings.

With this welding control method, an effect of disturbance can be avoided.
(10) The welding control method according to any of (1) to (3), in which the molten pool information includes at least a distance between a predetermined position in the welding image and a tip of a molten pool or area of the molten pool.

With this welding control method, appropriate welding control can be performed on the basis of the molten value information.
(11) The welding control method according to (10), in which the predetermined position is a position of a wire tip or an arc center point.

With this welding control method, the welding control can be appropriately performed on the basis of the molten value information based on the position of the wire tip or the arc center point.
(12) The welding control method according to any of (1) to (3),
in which the gap width and the molten pool information relating to the welding proceeding direction are obtained on a basis of feature information for calculating the molten pool information relating to the welding proceeding direction output by inputting the welding image to a trained model that receives the welding image as input data and that outputs at least the gap width and the feature information.

With this welding control method, the gap width and the molten pool information can be obtained from the welding image using the trained model.
(13) The welding control method according to (5),
in which, if the difference value is a value outside a range defined by the first threshold, one of following types of processing is performed:
setting the difference value to a predetermined value;
not performing the correction step based on the difference value;
outputting a signal indicating that the value is outside the range; and
stopping a robot control apparatus.

With this welding control method, appropriate welding control can be performed by detecting a case where the difference value becomes an extreme value.
(14) The welding control method according to (7),
in which, if the integral value is a value outside a range defined by the second threshold, one of following types of processing is performed:
setting the integral value to a predetermined value;
not performing the correction step based on the integral value;
outputting a signal indicating that the value is outside the range; and
stopping a robot control apparatus.

With this welding control method, appropriate welding control can be performed by detecting a case where the integral value becomes an extreme value.
(15) The welding control method according to (8),
in which, if the setting value of the welding condition is a value outside a range defined by the third threshold and the fourth threshold, one of following types of processing is performed:
setting the setting value of the welding condition to a predetermined value;
not performing the correction step based on the setting value of the welding condition;
outputting a signal indicating that the value is outside the range; and
stopping a robot control apparatus.

With this welding control method, appropriate welding control can be performed by detecting a case where the setting value of the welding condition becomes an extreme value.
(16) A welding system including at least:
a welding robot;
a robot control apparatus; and
an imaging apparatus,
in which the imaging apparatus captures a welding image during welding performed by the welding robot, and
in which the robot control apparatus
obtains at least a gap width at predetermined time intervals on a basis of the welding image,
determines a target value of molten pool information relating to a welding proceeding direction on a basis of the gap width,
calculates a difference value between a calculated value of the molten pool information relating to the welding proceeding direction and the target value, and
corrects at least one of setting values of welding conditions on a basis of the difference value.

With this welding system, stable welding quality can be maintained in any situation in welding control that uses a welding image.
(17) A welding control program causing a processor included in an apparatus to achieve:
an obtaining function of obtaining at least a gap width at predetermined time intervals on a basis of a welding image obtained during welding;
a target value determination function of determining a target value of molten pool information relating to a welding proceeding direction on a basis of the gap width;
a difference value calculation function of calculating a difference value between a calculated value of the molten pool information relating to the welding proceeding direction and the target value; and
a correction function of correcting at least one of setting values of welding conditions on a basis of the difference value.

With this welding control program, stable welding quality can be maintained in any situation in welding control that uses a welding image.

Although various embodiments have been described, it is needless to say that the present invention is not limited to these examples. It is obvious that those skilled in the art can conceive various modifications and corrections within the scope of the claims, and it should be understood that such modifications and corrections naturally pertain to the technical scope of the present invention. In addition, components of the above embodiments may be combined in any manner without deviating from the scope of the invention.

Note that the present application is based on Japanese Patent Application (Japanese Patent Application No. 2023-066550) filed on Apr. 14, 2023, the contents of which are incorporated herein by reference.

### REFERENCE SIGNS LIST

10 groove
14 backing material
15 molten pool
16 arc
50 welding system
100 mobile welding robot
200 torch
210 nozzle
211 welding wire
300 feeding apparatus
400 welding power supply
410 power cable
420 conduit tube
430 power cable
500 shielding gas supply source
510 gas tube
600 robot control apparatus
601 data holding unit
602 groove shape information calculation section
603 welding condition obtaining section
604 control unit
610 robot control cable
620 power supply control cable
700 imaging apparatus
800 data processing apparatus
810 body
815 nonvolatile storage device
815A learning program
815B trained model
815C information generation program
815D image data
816 input/output interface
817 communication interface
818 image output interface
819 calculation unit
820 input unit
830 display unit

1. A welding control method for controlling welding conditions on a basis of a welding image obtained during welding, the welding control method comprising:
an obtaining step of obtaining at least a gap width at predetermined time intervals on a basis of the welding image;
a target value determination step of determining a target value of molten pool information relating to a welding proceeding direction on a basis of the gap width;
a difference value calculation step of calculating a difference value between a calculated value of the molten pool information relating to the welding proceeding direction and the target value; and
a correction step of correcting at least one of setting values of the welding conditions on a basis of the difference value.

2. The welding control method according to claim 1, further comprising:
a changing step of changing the setting values of the welding conditions on a basis of the gap width,
wherein the setting values of the welding conditions to be changed in the changing step include at least one of a welding current, an arc voltage, a welding speed, an offset value, a weaving width, and a weaving end stop period.

3. The welding control method according to claim 2,
wherein the setting values of the welding conditions to be changed in the changing step are obtained on a basis of a database storing the gap width and relationships between the gap width and the setting values of the welding conditions for each of predetermined standard items.

4. The welding control method according to claim 1,
wherein the setting values of the welding conditions to be corrected in the correction step include at least the welding speed.

5. The welding control method according to claim 1, further comprising:
a step of applying a first limit to the difference value on a basis of a predetermined first threshold.

6. The welding control method according to claim 1,
wherein, in the correction step, at least one of the setting values of the welding conditions is corrected on a basis of a calculation formula including at least a term obtained by multiplying the difference value by a predetermined first coefficient and a term obtained by multiplying an integral value of the difference value by a predetermined second coefficient.

7. The welding control method according to claim 6, further comprising:
a step of applying a second limiter to the integral value on a basis of a predetermined second threshold.

8. The welding control method according to claim 1, further comprising:
a step of applying a third limiter to the welding condition corrected in the correction step on a basis of a predetermined third threshold and a predetermined fourth threshold,
wherein the third threshold is a value that defines a lower limit of the setting value of the welding condition, and
wherein the fourth threshold is a value that defines an upper limit of the setting value of the welding condition.

9. The welding control method according to claim 1, further comprising:
a step of calculating the calculated value of the molten pool information relating to the welding proceeding direction as a moving average of two or more calculated values of molten pool information regarding the two or more welding image captured at successive timings.

10. The welding control method according to claim 1,
wherein the molten pool information includes at least a distance between a predetermined position in the welding image and a tip of a molten pool or area of the molten pool.

11. The welding control method according to claim 10,
wherein the predetermined position is a position of a wire tip or an arc center point.

12. The welding control method according to claim 1,
wherein the gap width and the molten pool information relating to the welding proceeding direction are obtained on a basis of feature information for calculating the molten pool information relating to the welding proceeding direction output by inputting the welding image to a trained model that receives the welding image as input data and that outputs at least the gap width and the feature information.

13. The welding control method according to claim 5,
wherein, if the difference value is a value outside a range defined by the first threshold, one of following types of processing is performed:
setting the difference value to a predetermined value;
not performing the correction step based on the difference value;
outputting a signal indicating that the value is outside the range; and
stopping a robot control apparatus.

14. The welding control method according to claim 7,
wherein, if the integral value is a value outside a range defined by the second threshold, one of following types of processing is performed:
setting the integral value to a predetermined value;
not performing the correction step based on the integral value;
outputting a signal indicating that the value is outside the range; and
stopping a robot control apparatus.

15. The welding control method according to claim 8,
wherein, if the setting value of the welding condition is a value outside a range defined by the third threshold and the fourth threshold, one of following types of processing is performed:
setting the setting value of the welding condition to a predetermined value;
not performing the correction step based on the setting value of the welding condition;
outputting a signal indicating that the value is outside the range; and
stopping a robot control apparatus.

16. A welding system comprising at least:
a welding robot;
a robot control apparatus; and
an imaging apparatus,
wherein the imaging apparatus captures a welding image during welding performed by the welding robot, and
wherein the robot control apparatus
obtains at least a gap width at predetermined time intervals on a basis of the welding image,
determines a target value of molten pool information relating to a welding proceeding direction on a basis of the gap width,
calculates a difference value between a calculated value of the molten pool information relating to the welding proceeding direction and the target value, and
corrects at least one of setting values of welding conditions on a basis of the difference value.

17. A welding control program causing a processor included in an apparatus to achieve:
an obtaining function of obtaining at least a gap width at predetermined time intervals on a basis of a welding image obtained during welding;
a target value determination function of determining a target value of molten pool information relating to a welding proceeding direction on a basis of the gap width;
a difference value calculation function of calculating a difference value between a calculated value of the molten pool information relating to the welding proceeding direction and the target value; and
a correction function of correcting at least one of setting values of welding conditions on a basis of the difference value.
